(19) United States
(12) Patent Application Publication
(10) Pub. No.: US 2015/0356455 A1
(43) Pub. Date: Dec. 10, 2015

(54) SYSTEMS AND METHODS ASSOCIATED WITH AN AUTO-TUNING SUPPORT VECTOR MACHINE

(71) Applicant: General Electric Company, Schenectady, NY (US)

(72) Inventors: Lei Wu, San Ramon, CA (US); Weizhong Yan, Clifton Park, NY (US); Jianhui Chen, Niskayuna, NY (US); Dong Ryeol Lee, Niskayuna, NY (US)

(21) Appl. No.: 14/298,282

(22) Filed: Jun. 6, 2014

(51) Int. Cl. G06N 7/02; G06F 17/16; G06N 99/00

(52) U.S. Cl. CPC G06N 7/02; G06N 99/005; G06F 17/16

(57) ABSTRACT

Some embodiments are associated with a support vector machine having model parameters. According to some embodiments, a set of evaluation data may be received and a computer processor may automatically tune the model parameters during a training process using the set of evaluation data. The automatically tuned model parameters for the support vector machine may then be output directly from the training process.

### BACKGROUND

The invention relates generally to support vector machines and, more particularly, to methods and systems for automatically tuning a support vector machine.

Support vector machines may be used, for example, to classify data points as being within either a first category or a second category. To make such a classification, the support vector machine may use parameters (e.g., model weighing values) that can be tuned to improve the performance of the support vector machine. The selection and tuning of appropriate parameter values for a support vector machine, however, can be a time consuming process, and it can be difficult to determine when substantially optimal performance has been achieved.

It would therefore be desirable to facilitate the determination of support vector machine parameters in such a way so as to improve the efficiency and/or the accuracy of the process.

### BRIEF DESCRIPTION

According to some embodiments, a set of evaluation data may be received and a computer processor may automatically tune the model parameters during a training process using the set of evaluation data. The automatically tuned model parameters for the support vector machine may then be output directly from the training process.

Other embodiments are associated with systems and/or computer-readable medium storing instructions to perform any of the methods described herein.

### DRAWINGS

FIG. 1 illustrates a graph containing data points that may be associated with a support vector machine.

FIG. 2 is a block diagram of a system that may be associated with a support vector machine.

FIG. 3 is a block diagram of a system that may be associated with a support vector machine in accordance with some embodiments.

FIG. 4 is a flow chart of a method in accordance with some embodiments.

FIG. 5 is an apparatus that may be provided in accordance with some embodiments.

FIG. 6 illustrates a system having a plurality of computational stations according to some embodiments.

FIG. 7 is a flow chart of a method in accordance with some embodiments.

### DETAILED DESCRIPTION

Some embodiments disclosed herein automatically tune model parameters for a support vector machine during a training process using a set of evaluation data. Some embodiments are associated with systems and/or computer-readable medium that may help perform such a method.

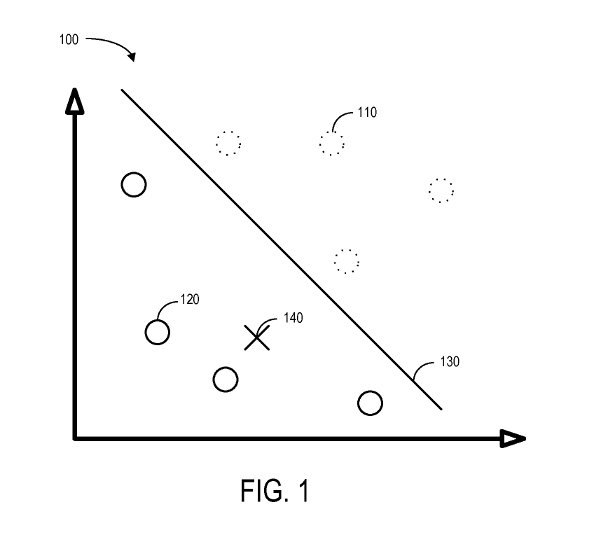

Support vector machines may be used, for example, to classify data points as being in either a first category or a second category. For example, FIG. 1 illustrates a graph 100 containing data points 110, 120 that may be associated with a support vector machine. The data points 110, 120 include those in a first category 110 (illustrated with dotted lines in FIG. 1) and those in a second category 120 (illustrated with solid lines in FIG. 1). A support vector machine may receive a new point 140 and make a determination as to which category that point 140 belongs to. To make such a determination, the existing data points 110, 120 may be analyzed to create a decision boundary 130. Note that although a two dimensional graph is illustrated in FIG. 1, an actual support vector machine may be associated with any number of dimensions. Moreover, although a linear decision boundary 130 is illustrated in FIG. 1, a support vector machine may be associated with a non-linear decision boundary.

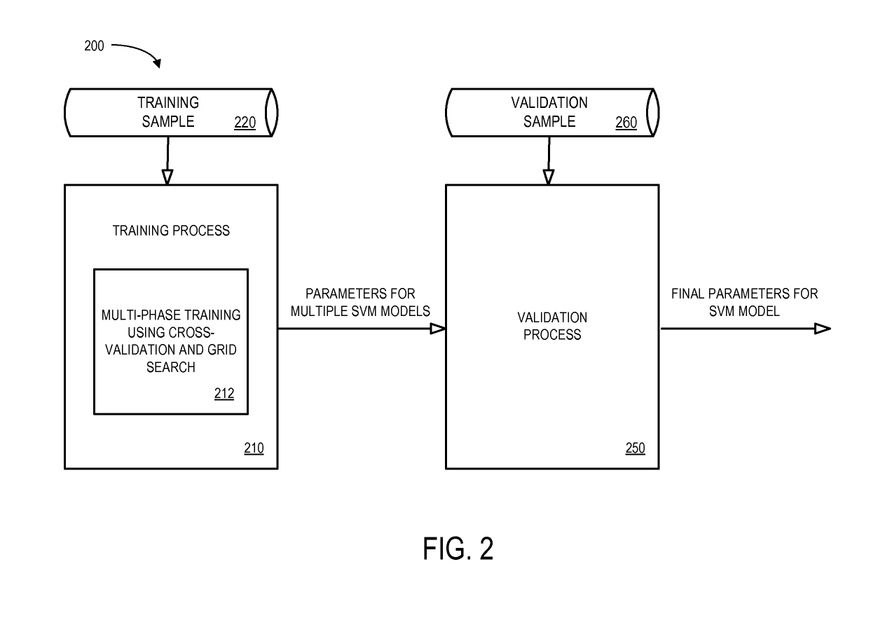

A part of the process of creating the decision boundary, the support vector machine may use parameters (e.g., model weighing values) that can be tuned to improve the performance of the support vector machine. For example, FIG. 2 is a block diagram of a system 200 that may be associated with a support vector machine. The system 200 includes a training process 210 that uses training sample data 220. In particular, the training process 210 may be associated with multi-phase training using cross validation and grid search 212 to create a parameters for multiple support vector machine models. A validation process 250 may use validation sample data 260 to evaluate the models in an iterative fashion until final parameters for the support vector model are created.

As will now be described, this system 200 for selecting and tuning appropriate parameter values for a support vector machine, however, can be a time consuming process. Moreover, it can be difficult to determine when a substantially optimal result has been achieved.

The concept of a support vector machine may be applied to many machine learning and pattern recognition applications, such as regression, classification, prognostics, etc. In many real world applications (e.g., machine learning and pattern recognition)s a support vector machine may be the most effective model, and is therefore widely used in artificial intelligence and data analytic applications. To achieve good support vector machine performance, several parameters may be tuned, including a penalty parameter C and other parameters for kernel tricks. The penalty parameter C may be interpreted in several ways. From the perspective of optimization, C adjusts the trade-off between a loss function and a regularization term. From the learning theory perspective, it controls the trade-off between the margin and the complexity of the model, which may be useful, for example, to help prevent over-fitting.

As illustrated in FIG. 2, the typical approach 200 to parameter tuning uses a separate training process 210 (with a training sample 220) and a validation process 250 (with a validation sample 260) and cross-validation, which adopts a grid search in the parameter space and evaluates an objective function on the validation sample 260 after each support vector machine training process 210 phase. There are several drawbacks with this type of cross-validation strategy. First, the method needs to train a support vector machine multiple times. The grid search in the parameter space requires the evaluation of a collection of parameter settings. With each parameter setting, the model has to be retrained. This is very time-consuming, especially when handling large-scale learning problems. Second, the grid search may not obtain the optimal parameter. Since the grid search only searches a few samples rather than the whole parameter space, cross-validation usually cannot guarantee optimal (or even sub-optimal) performance.

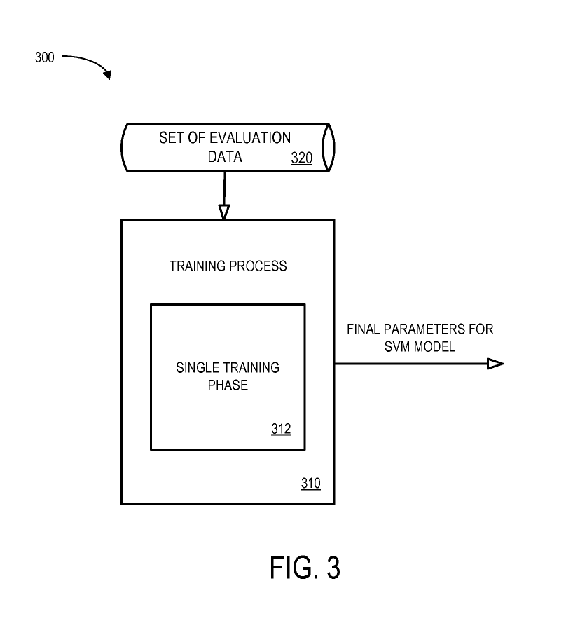

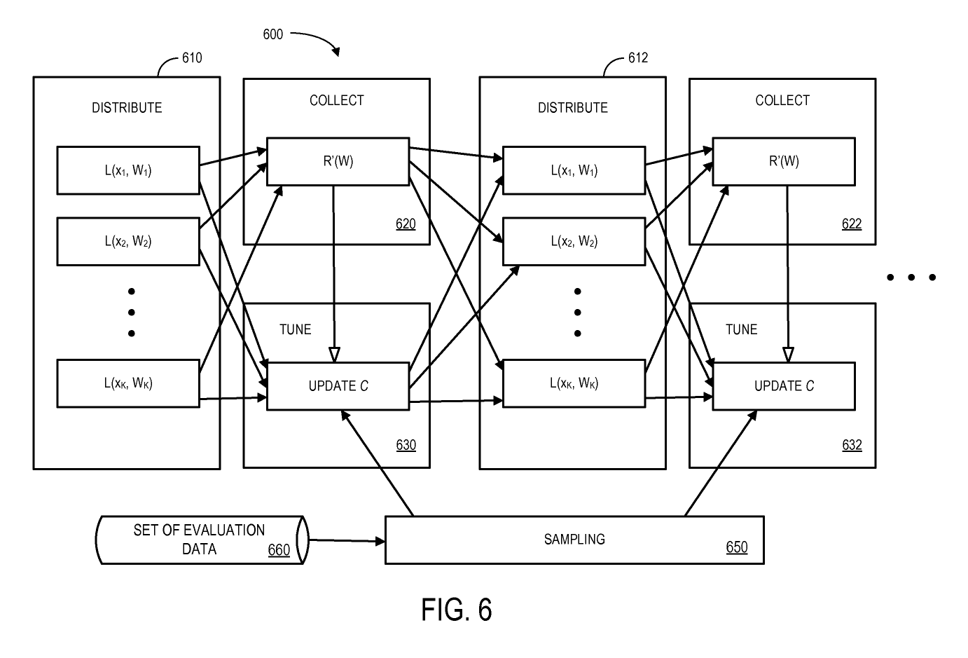

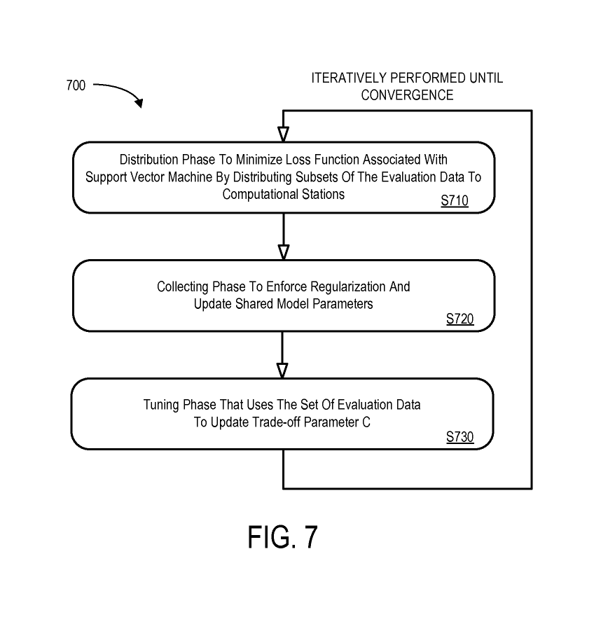

To tackle these challenges, some embodiments described herein use an auto-tuning support vector machine, which may automatically optimize the parameters within the support vector machine training process. For example, FIG. 3 illustrates a system 300 wherein a training process 310 uses a single training phase 312 and a set of evaluation data 320 to create final parameters for a support vector machine model. In this way, model retraining may be avoided, and the parameter setting may be optimized singe model training phase 312 loop. Such an auto-tuning support vector machine system 300 may be suitable to handle large-scale problem for two reasons. First, the most time-consuming retraining phase may be avoided, because the parameter tuning may be done in one training loop. Second, the parameter tuning may be incorporated into a distributed learning framework in a relatively straightforward way as described with respect to FIGS. 6 and 7 herein.

A previously mentioned, a support vector machine may be associated with linear or non-linear models for regression and classification. The standard formulation of support vector machine is to solve the binary prediction problem as a linear classifier, while kernel tricks and variations make a support vector machine a non-linear model for both classification and regression problems. The object of a support vector machine is to search for a d−1 dimensional decision boundary that can maximize the margin between two classes. The optimal decision boundary is called the “maximum-margin hyperplane,” and the model is also referred to as a “maximum-margin classifier.”

The primal form of the model is:

min_{w,b}½∥w∥²+∝

s.t.yᵢ(wxᵢ−b)≧1−∝

where w represents a weight and b is associated with an offset value.

With stationary conditions, the solution for linear support vector machine can be expressed as:

$$w = {Σ}_{i} {α}_{i} {y}_{i} {x}_{i}$$

$$b = \frac{1}{{N}_{SV}} {Σ}_{i = 1}^{{N}_{SV}} ( {wx}_{i} - {y}_{i} )$$

where N_{SV} represents a total number of support vectors.

For a non-linear support vector machine, w may be calculated in the transformed space,

$$with = {Σ}_{i} {α}_{i} {y}_{i} φ ( {x}_{i} ) and b = \frac{1}{{N}_{SV}} {Σ}_{i = 1}^{{N}_{SV}} ( w φ ( {x}_{i} ) - {y}_{i} ) ,$$

where ø is associated with a transformation function of x. The dual parameter øᵢ may be found from:

max_{0≦α}_{ᵢ}_{≦C}(Σᵢαᵢ−½Σ_{i,j}αᵢαⱼyᵢyⱼKᵢⱼ)

and Kᵢⱼ=K(xᵢ, xⱼ) are the entries in the Kernel matrix K. The kernel is calculated as K(x, x′)=ø(x)·ø(x′). For the linear support vector machine, ø(x)=x, and for the non-linear support vector machine, ø can be other non-linear functions.

The dual form of the model may comprise:

max_{α}_{ᵢ}Σᵢαᵢ−½Σ_{i,j}αᵢαⱼyᵢyⱼk(xᵢ,xⱼ)

s.t.αᵢ≧0,Σᵢαᵢyᵢ=0

where k(·) is the kernel used in the model. Linear kernel and Gaussian radial basis functions are commonly used kernels, but note that many other models may also be used.

Since mislabeled samples may have a substantial impact on the decision boundary, a soft margin version may be used according to some embodiments. The primal form of the soft margin model may be represented as follows:

min_{w,b,ξ}½∥w∥²+CΣᵢξᵢ

s.t.yᵢ(wxᵢ−b)≧1−ξᵢ,ξᵢ≧0

where ξᵢ is a non-negative slack variable associated with a degree of misclassification of the data xᵢ.

and the dual form is

max_{α}_{ᵢ}Σᵢ−½αᵢαⱼyᵢyⱼk(xᵢ,xⱼ)

s.t.0≦αᵢ≦C,Σᵢαᵢyᵢ=0

Note that cross-validation typically aims to extend the generalization capability of the model to an independent dataset. Thus, a goal of this type of parameter tuning may be to reduce the generalization error. Usually, cross-validation divides the data into two parts: training samples Xₜ and validation samples Xᵥ. The training samples are used to train the model, and the validation samples are used to estimate the generalization error. This tuning process consists of two phases, one is the training phase, and the other is the validation phase. First a collection of attempting parameters may be defined. Let the n attempting parameters be C={Cᵢ, C₂, . . . , Cₙ}. With each parameter Cᵢ a support vector machine model Mᵢ may be trained on the training data Xₜ. Then all of the models are evaluated on the validation dataset Xᵥ. Let e(Cᵢ) be the generalization error for the model with parameter Cᵢ. The best parameter may be chosen as the one with the smallest generalization error:

C*=min_{C}_{ᵢ}e(Cᵢ)

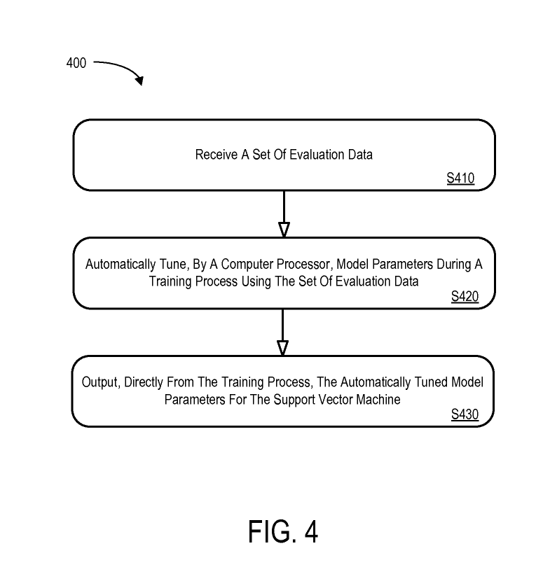

According to some embodiment, an automatic tuning support vector machine may incorporate a parameter tuning process into model learning. As a result, the tuning process may be automatic and only a single run of the model training may be required. Consider, for example, FIG. 4 which is a flow chart of a method 400 associated with a support vector machine having model parameters in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

At S410, a set of evaluation data may be received. At S420, a computer processor may automatically tune model parameters during a training process using the set of evaluation data. The automatic tuning may be performed, for example, during a single phase of the training process.

At S430, the automatically tuned model parameters for the support vector machine may be output directly from the training process. The parameters may then be used to automatically render decisions using the support vector machine. The decisions may be associated with, for example, classification, clustering, regression, anomaly detection, association rules, reinforcement learning, structured prediction, feature learning, online learning, semi-supervised learning, and/or grammar induction.

Generally, the optimization problem associated with a support vector machine may be considered in the following form:

min_{w}_{_{C}}_{C}Σ_{(x,y)εD}_{ₜ}Cl(y,w_{C},ø(x))+½∥w_{C}∥²

s.t.C=arg min_{η}ε_{(x,y)εD}_{ᵥ}l(y,w_{η},ø(x)),C>0

where C is the trade-off parameter, w_{C} is the variable dependent on parameter C, Dₜ is the set of training data, Dᵥ is the set of validation data, and l( ) is the loss function.

The augmented Lagrangian for the above optimization may be represented as:

Lλ(w_{C},C,β)=Σ_{(x,y)εD}_{ₜ}Cl(y,w_{C},ø(x))+½∥w_{C}∥²+β∥C−arg min_{η}Σ_{(x,y)εD}_{ᵥ}l(y,w_{η},ø(x))∥²

where w_{C} is the primal variable, β is a parameter for the Lagrangian, and β>0 is the dual variable. The equality constraint may be considered to minimize a regularization term of C. If R(C)=C−arg min_{η}Σ_{(x,y)εD}_{ᵥ}l(y,w_{η},ø(x)), the following may represent the problem:

$${L}_{λ} ( {w}_{C} , α , C , β ) = C {Σ}_{( x , y ) ∈ {D}_{t}} l ( {yw}_{C} \cdot φ ( x ) ) + \frac{1}{2} {‖ z ‖}^{2} + 〈 α , {w}_{C} - z 〉 + \frac{λ}{2} ‖ w - z ‖ + β R ( C )$$

where w_{C} is the primal variable, z represents the average of all w values (over many computational stations), α is the dual variable, and λ>0 is the penalty parameter. In some cases, the equality constraint may be considered to minimize a regularization term of C. Let R(C)=∥C−arg min_{η}Σ_{(x,y)εD}_{ᵥ}l(y,w_{η},ø(x))∥².

The solving of such a problem may, according to some embodiments, be performed in the following iterative steps:

$${w}_{t + 1} = arg {min}_{w} Cl ( {α}_{i} w \cdot φ ( x ) ) + 〈 {α}_{t} , w - z 〉 + \frac{λ}{2} {‖ w - z ‖}^{2}$$

$${z}_{t + 1} = arg {min}_{z} β \frac{1}{2} ‖ z ‖ + 〈 {α}_{t} , w - z 〉 + \frac{λ}{2} {‖ w - z ‖}^{2}$$

$${α}_{t + 1} = {α}_{t} + λ ( w - z )$$

$${C}_{t + 1} = {C}_{t} - γ ( {Σ}_{( x , y ) ∈ {D}_{v}} l ( y , {w}_{C} \cdot φ ( x ) ) + 2 β \frac{\partial R ( {C}_{t} )}{\partial ( {C}_{t} )} )$$

where xᵥ represents the sample of the validation data, and η is a learning rate.

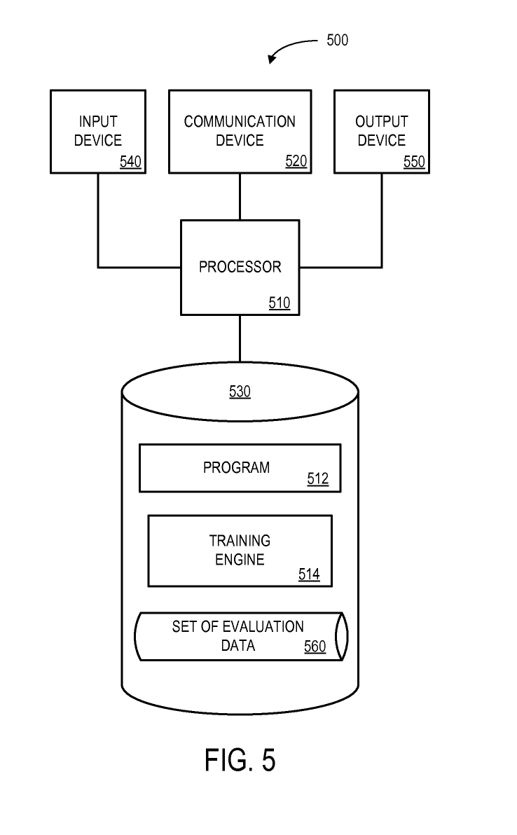

The embodiments described herein may be implemented using any number of different hardware configurations. For example, FIG. 5 illustrates an apparatus 500 that may be, for example, associated with the system 300 of FIG. 3 and/or method of FIG. 4. The apparatus 500 comprises a processor 510, such as one or more commercially available Central Processing Units (CPUs) in the form of one-chip microprocessors, coupled to a communication device 520 configured to communicate via a communication network (not shown in FIG. 5). The apparatus 500 further includes an input device 540 (e.g., a mouse and/or keyboard to enter information about datasets) and an output device 550 (e.g., a computer monitor to output information about support vector machines).

The processor 510 also communicates with a storage device 530. The storage device 530 may comprise any appropriate information storage device, including combinations of magnetic storage devices (e.g., a hard disk drive), optical storage devices, mobile telephones, and/or semiconductor memory devices. The storage device 530 stores a program 512 and/or a training engine 514 (e.g., associated with a support vector machine training process) for controlling the processor 510. The processor 510 performs instructions of the programs 512, 514, and thereby operates in accordance with any of the embodiments described herein. For example, the processor 510 may receive a set of evaluation data 560 and automatically tune model parameters during a training process using the set of evaluation data 560. The automatically tuned model parameters for the support vector machine may then be output by the processor 510 directly from the training process.

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

As used herein, information may be “received” by or “transmitted” to, for example: (i) the apparatus 500 from another device; or (ii) a software application or module within the apparatus 500 from another software application, module, or any other source.

Although FIG. 5 illustrates an embodiment using a single computational station, to handle a big data problem embodiments may distribute an optimization process into multiple computational stations. According to some embodiments, an auto-tuning support vector machine problem may be solved using an Alternating Direction Method of Multipliers (“ADMM”) framework.

FIG. 6 illustrates a system 600 having a plurality of computational stations according to some embodiments. The system 600 may provide a distributed version of the training process, and may be associated with application of some embodiments to a big data learning scenario. In particular, the system 600 includes computational stations associated with a distribute function 610, a collect function 620, and a tune function 630. Sampling 650 may receive a set of evaluation data 660 and provide information to tune function 630 in order to update C. Note that multiple sets of distribute functions 612, collect functions 622, and tune functions 632 may be provided as illustrated in FIG. 6. The distribute function 610 may minimize the objective function. According to some embodiments, the distribute function 610 may try to minimize the loss function in the objective by decoupling the formulation and distributing the data and computation to different nodes in the system 600. The collect function 620 may minimize the regularization term, and may enforce a regularization and update shared parameters. Note that distributed weighting may be collected into one master station and used to update the regularization. The tune function 630 may update parameter C. The updating of C may be based on the sampling of the set of evaluation data 660. These functions 610, 620, 630 may work together iteratively until convergence to solve a big data problem.

FIG. 7 is a flow chart of a method associated with FIG. 6 in accordance with some embodiments wherein the automatic tuning is performed by a set of i computational stations, where i is an integer greater than 1. The steps of FIG. 7 may be performed, according to some embodiments, until convergence is achieved.

In this framework, there are basically three phases. At S710 the distributing phase may try to minimize the loss function in the objective by decoupling the formulation and distributing the data and computation to different nodes. This process will update the decoupled parameters.

$${w}_{t + 1} ( i ) = arg {min}_{w ( i )} Cl ( {α}_{i} w ( i ) \cdot φ ( x ( i ) ) ) + 〈 {α}_{i} , w ( i ) - z 〉 + \frac{λ}{2} {‖ w ( i ) - z ‖}^{2}$$

Note that w(i) may represent the decision boundary for each subset of training data that is distributed to the ith slave computational station. Since all of those w(i) are decoupled in the updating equation, the optimization may be distributed. This phase may use the distributed subset of the training data x(i) for the decision boundary updating.

At S720 the collecting phase may enforce a regularization and update shared parameters.

$${z}_{t + 1} = arg {min}_{z} β \frac{1}{2} ‖ z ‖ + {Σ}_{i} ( 〈 {α}_{t} , {w}_{C} ( i ) - z 〉 + \frac{λ}{2} {‖ {w}_{C} ( i ) - z ‖}^{2} )$$

In this phase, all of the distributed weighting may be collected into one master station and used to update the regularization.

At S730 the validation phase may be performed in the evaluation data with the goal of updating the trade-off parameter C.

$${C}_{t + 1} = {C}_{t} - γ ( {Σ}_{( x , y ) ∈ {D}_{v}} l ( yz \cdot φ ( x ) ) + 2 β \frac{\partial R ( {C}_{t} )}{\partial ( {C}_{t} )} )$$

This case may be performed on the validation data Dᵥ. These three phases may be iteratively performed until convergence.

As compared to the typical cross-validation method for support vector machines, there are several advantages using the auto-tuning support vector machine. For example, the auto-tuning vector machine may be more efficient. Note that cross-validation uses a grid search for the best parameter setting, which needs to run multiple model training phases. The auto-tuning support vector machine may only need one model training phase, and the parameter tuning may be done automatically. As another advantage, the auto-tuning support vector machine help achieve optimal or suboptimal settings for the support vector machine, while cross-validation cannot guarantee such a result. An auto-tuning support vector machine adopts a stochastic gradient decent approach, which may obtain a global optimal setting if the objective function is strongly convex, and a suboptimal setting otherwise. Moreover, some embodiments described herein may facilitate distributed computing. The parallel auto-tuning support vector machine algorithm may provide an advantage, for example, when handling big data learning problems.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Embodiments described herein may be used in connection with any of a number of different applications. By way of a single example only, a set of evaluation data associated with the operation of jet engines might be received. Model parameters for a support vector machine might be automatically tuned during a training process using that set of evaluation data. The automatically tuned model parameters for the support vector machine may then be output directly from the training process. These parameters might then be used to incorporate an appropriate support vector machine into a jet engine diagnostics platform (e.g., to help the platform automatically decide when a maintenance operation should be performed).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A computer-implemented method associated with a support vector machine having model parameters, comprising:
receiving a set of evaluation data;
automatically tuning, by a computer processor, model parameters during a training process using the set of evaluation data; and
outputting, directly from the training process, the automatically tuned model parameters for the support vector machine.

2. The method of claim 1, wherein said automatic tuning is performed during a single phase of the training process.

3. The method of claim 1, further comprising:
automatically rendering decisions using the support vector machine.

4. The method of claim 3, wherein the decisions are associated with at least one of: (i) classification, (ii) clustering, (iii) regression, (iv) anomaly detection, (v) association rules, (vi) reinforcement learning, (vii) structured prediction, (viii) feature learning, (ix) online learning, (x) semi-supervised learning, and (xi) grammar induction.

5. The method of claim 1, wherein said automatic tuning is performed by a set of i computational stations, where i is an integer greater than 1.

6. The method of claim 5, wherein said automatic tuning is performed by iteratively performing the following phases until convergence is achieved:
a distribution phase to minimize a loss function associated with the support vector machine by distributing subsets of the evaluation data to the i computational stations;
a collecting phase to enforce regularization and update shared model parameters; and
a tuning phase that uses the set of evaluation data to update a trade-off parameter C.

7. The method of claim 6, wherein the distribution phase updates decoupled parameters, wherein w(i) represents a decision boundary for each subset of evaluation data x(i) distributed to an ith slave computational station as follows:
$${w}_{t + 1} ( i ) = arg {min}_{w ( i )} Cl ( {α}_{i} w ( i ) \cdot φ ( x ( i ) ) ) + 〈 {α}_{i} , w ( i ) - z 〉 + \frac{λ}{2} {‖ w ( i ) - z ‖}^{2}$$

8. The method of claim 6, wherein the collection phase collects distributed weighting parameters at a master computational station and updates regularization as follows:
$${z}_{t + 1} = arg {min}_{z} β \frac{1}{2} ‖ z ‖ + {\sum }_{i}^{ } ( 〈 {α}_{t} , {w}_{C} ( i ) - z 〉 + \frac{λ}{2} {‖ {w}_{C} ( i ) - z ‖}^{2} )$$

9. The method of claim 6, wherein the tuning phase updates the trade-off parameter C as follows:
$${C}_{t + 1} = {C}_{t} - γ ( {\sum }_{( x , y ) ∈ {D}_{v}} l ( yz \cdot φ ( x ) ) + 2 β \frac{\partial R ( {C}_{t} )}{\partial ( {C}_{t} )} )$$

10. A non-transitory, computer-readable medium storing instructions that, when executed by a computer processor, cause the computer processor to perform a method associated with a support vector machine having model parameters, the method comprising:
receiving a set of evaluation data;
automatically tuning, by the computer processor, the model parameters during a training process using the set of evaluation data; and
outputting, directly from the training process, the automatically tuned model parameters for the support vector machine.

11. The medium of claim 10, wherein said automatic tuning is performed during a single phase of the training process.

12. The medium of claim 10, wherein the method further comprises:
automatically rendering decisions using the support vector machine, wherein the decisions are associated with at least one of: (i) classification, (ii) clustering, (iii) regression, (iv) anomaly detection, (v) association rules, (vi) reinforcement learning, (vii) structured prediction, (viii) feature learning, (ix) online learning, (x) semi-supervised learning, and (xi) grammar induction.

13. The medium of claim 10, wherein said automatic tuning is performed by a set of i computational stations, where i is an integer greater than 1, by iteratively performing the following phases until convergence is achieved:
a distribution phase to minimize a loss function associated with the support vector machine by distributing subsets of the evaluation data to the i computational stations;
a collecting phase to enforce regularization and update shared model parameters; and
a tuning phase that uses the set of evaluation data to update a trade-off parameter C.

14. The medium of claim 13, wherein the distribution phase updates decoupled parameters, wherein w(i) represents a decision boundary for each subset of evaluation data x(i) distributed to an ith slave computational station as follows:
$${w}_{t + 1} ( i ) = arg {min}_{w ( i )} Cl ( {α}_{i} w ( i ) \cdot φ ( x ( i ) ) ) + 〈 {α}_{i} , w ( i ) - z 〉 + \frac{λ}{2} {‖ w ( i ) - z ‖}^{2}$$

15. The medium of claim 13, wherein the collection phase collects distributed weighting parameters at a master computational station and updates regularization as follows:
$${z}_{t + 1} = arg {min}_{z} β \frac{1}{2} ‖ z ‖ + {\sum }_{i}^{ } ( 〈 {α}_{t} , {w}_{C} ( i ) - z 〉 + \frac{λ}{2} {‖ {w}_{C} ( i ) - z ‖}^{2} )$$

16. The medium of claim 13, wherein the tuning phase updates the trade-off parameter C as follows:
$${C}_{t + 1} = {C}_{t} - γ ( {\sum }_{( x , y ) ∈ {D}_{v}} l ( yz \cdot φ ( x ) ) + 2 β \frac{\partial R ( {C}_{t} )}{\partial ( {C}_{t} )} )$$

17. A system, comprising:
a storage device to store a set of evaluation data; and
a computer system coupled to the storage device to: (i) automatically tune the model parameters during a training process using the set of evaluation data, and (ii) output, directly from the training process, the automatically tuned model parameters for the support vector machine.

18. The system of claim 17, wherein said automatic tuning is performed during a single phase of the training process.

19. The system of claim 17, wherein the method further comprises:
automatically rendering decisions using the support vector machine, wherein the decisions are associated with at least one of: (i) classification, (ii) clustering, (iii) regression, (iv) anomaly detection, (v) association rules, (vi) reinforcement learning, (vii) structured prediction, (viii) feature learning, (ix) online learning, (x) semi-supervised learning, and (xi) grammar induction.

20. The system of claim 17, wherein said automatic tuning is performed by a set of i computational stations, where i is an integer greater than 1, by iteratively performing the following phases until convergence is achieved:
a distribution phase to minimize a loss function associated with the support vector machine by distributing subsets of the evaluation data to the i computational stations;
a collecting phase to enforce regularization and update shared model parameters; and
a tuning phase that uses the set of evaluation data to update a trade-off parameter C.
